(19) United States
(12) Patent Application Publication
(10) Pub. No.: US 2024/0342589 A1
(43) Pub. Date: Oct. 17, 2024

(54) HOT ZONE ADJUSTMENT METHOD AND APPARATUS, DEVICE, STORAGE MEDIUM, AND PROGRAM PRODUCT

(71) Applicant: Tencent Technology (Shenzhen) Company Limited, Shenzhen (CN)

(72) Inventor: Ziyi WANG, Shenzhen (CN)

(73) Assignee: Tencent Technology (Shenzhen) Company Limited, Shenzhen (CN)

(21) Appl. No.: 18/751,152

(22) Filed: Jun. 21, 2024

Related U.S. Application Data
(63) Continuation of application No. PCT/CN2023/111162, filed on Aug. 4, 2023.

(30) Foreign Application Priority Data
Sep. 5, 2022 (CN) 202211077290.0

(51) Int. Cl. A63F 13/214; A63F 13/42; A63F 13/55; G06T 17/00

(52) U.S. Cl. CPC A63F 13/214; A63F 13/42; A63F 13/55; G06T 17/00

(57) ABSTRACT

In a hot zone adjustment method, a hot zone adjustment interface of an application is displayed. The hot zone is a touch control region for executing a control function of a virtual character, and the virtual character is configured to move in a virtual world provided by the application. A user operation for a first hot zone is received. The parameter of the first hot zone is customized in response to the user operation for the first hot zone.

### RELATED APPLICATIONS

The present application is a continuation of International Application No. PCT/CN2023/111162, filed on Aug. 4, 2023, which claims priority to Chinese Patent Application No. 202211077290.0, filed on Sep. 5, 2022. The entire disclosures of the prior applications are hereby incorporated by reference.

### FIELD OF THE TECHNOLOGY

Aspects of this disclosure relate to the field of user interfaces, including to a hot zone adjustment method and apparatus, a device, a storage medium, and a program product.

### BACKGROUND OF THE DISCLOSURE

In an online game with a virtual environment, such as a multiplayer online role-playing game, a player may play one or more virtual characters and control activities and behaviors of the virtual characters in a virtual world in the game.

In related technologies, by clicking on a plurality of operation controls and default hot zones displayed in a user interface, the virtual characters may be controlled to move in the virtual environment.

However, in related technologies, the shape of the operation controls is default and fixed, and the shape, size, and function of the hot zones are default and fixed. Gaps between the operation controls of a fixed shape cause a waste of space in the user interface. At the same time, if the size of the operation controls is too large or too small, the operation accuracy of the player will be reduced, and the operation convenience will be low.

### SUMMARY

Aspects of this disclosure provide a hot zone adjustment method and apparatus, a device, a storage medium, and a program product. Examples of technical solutions are as follows:

According to one aspect of this disclosure, a hot zone adjustment method is provided. The hot zone adjustment interface of an application is displayed by processing circuitry of a terminal. The hot zone adjustment interface is configured to adjust at least one hot zone. The hot zone is a touch control region that is configured to execute a control function of a virtual character. The virtual character is configured to move in a virtual world provided by the application. A user operation for a first hot zone is received. At least one parameter of the first hot zone is customized in response to the user custom operation for the first hot zone, at least one parameter of the first hot zone.

According to an aspect of this disclosure, a hot zone adjustment apparatus is provided. The processing circuitry is configured to display a hot zone adjustment interface of an application. The hot zone being a touch control region for executing a control function of a virtual character. The virtual character being configured to move in a virtual world provided by the application. The processing circuitry is configured to receive a user operation for a first hot zone and customize at least one parameter of the first hot zone in response to the user operation for the first hot zone.

According to an aspect of this disclosure, a computer device is provided. The computer device includes: a processor and a memory. The memory has at least one computer program stored therein. The at least one computer program is loaded and executed by the processor to implement the hot zone adjustment method as described in the above aspect.

According to an aspect of this disclosure, a non-transitory computer-readable storage medium is provided. The non-transitory computer-readable storage medium storing at least one instruction which when executed by a processor causes the processor to implement the hot zone adjustment method as described in the above aspect.

According to an aspect of this disclosure, a computer program product is provided. The computer program product includes computer programs. The computer programs are stored in a computer-readable storage medium. The computer programs are read and executed by a processor of a computer device from the computer-readable storage medium, whereby the computer device performs the hot zone adjustment method as described in the above aspect.

The beneficial effects brought about by the technical solutions provided in this disclosure at least include:

A hot zone adjustment interface of a game application is displayed, and a custom operation for a first hot zone in at least one hot zone is received. In response to the custom operation for the first hot zone, at least one parameter of the first hot zone is customized. This disclosure provides a method for customizing hot zones, which customizes and adjusts hot zones in a user interface, thereby reducing the waste of space in the user interface caused by gaps between operation controls of a fixed shape, and also improving the convenience of operation.

### BRIEF DESCRIPTION OF THE DRAWINGS

FIG. 1 is a schematic diagram of a hot zone adjustment method according to an aspect of this disclosure.

FIG. 2 is a structural block diagram of a computer system according to an aspect of this disclosure.

FIG. 3 is a flowchart of a hot zone adjustment method according to an aspect of this disclosure.

FIG. 4 is a flowchart of a hot zone adjustment method according to an aspect of this disclosure.

FIG. 5 is a schematic diagram of a hot zone adjustment method according to an aspect of this disclosure.

FIG. 6 is a schematic diagram of a hot zone according to an aspect of this disclosure.

FIG. 7 is a schematic diagram of a hot zone according to an aspect of this disclosure.

FIG. 8 is a schematic diagram of a hot zone adjustment interface according to an aspect of this disclosure.

FIG. 9 is a schematic diagram of a hot zone adjustment interface according to an aspect of this disclosure.

FIG. 10 is a schematic diagram of a hot zone adjustment interface according to an aspect of this disclosure.

FIG. 11 is a schematic diagram of a hot zone adjustment method according to an aspect of this disclosure.

FIG. 12 is a flowchart of a hot zone adjustment method according to an aspect of this disclosure.

FIG. 13 is a flowchart of a hot zone adjustment method according to an aspect of this disclosure.

FIG. 14 is a flowchart of a hot zone adjustment method according to an aspect of this disclosure.

FIG. 15 is a flowchart of a hot zone adjustment method according to an aspect of this disclosure.

FIG. 16 is a block diagram of a hot zone adjustment apparatus according to an aspect of this disclosure.

FIG. 17 is a schematic diagram of an apparatus structure of a computer device according to an aspect of this disclosure.

### DETAILED DESCRIPTION

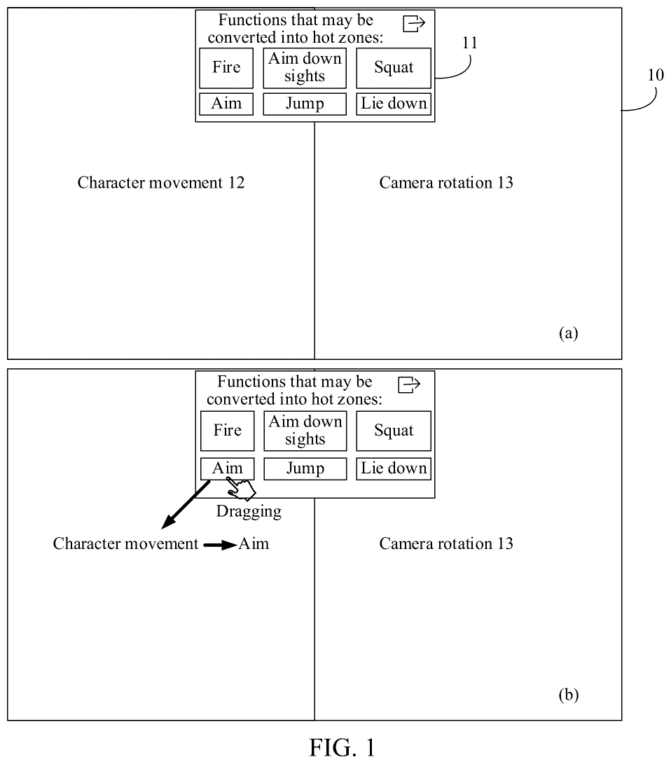

This disclosure provides a technical solution of a hot zone adjustment method. The method may be performed by a terminal or a client on the terminal. As shown in FIG. 1(a), a hot zone adjustment interface 10 of a game application is displayed in a terminal. The terminal receives a custom operation for a first hot zone in the at least one hot zone. The terminal customizes, in response to the custom operation for the first hot zone, at least one parameter of the first hot zone.

The hot zone adjustment interface 10 is configured for adjusting the at least one hot zone.

The hot zone is a touch control region for executing a control function of a virtual character and the hot zone does not have a control display form. The virtual character is configured for moving in a virtual world provided by the game application.

By way of example, the operation that the terminal customizes, in response to the custom operation for the first hot zone, at least one parameter of the first hot zone includes at least one of the following:
The terminal customizes, in response to a first custom operation for the first hot zone, a function parameter of the first hot zone.
The terminal customizes, in response to a second custom operation for the first hot zone, a location parameter of the first hot zone.
The terminal customizes, in response to a third custom operation for the first hot zone, a size parameter of the first hot zone.

As shown in FIG. 1(a), a hot zone adjustment interface 10 of a game application is displayed in a terminal. The hot zone adjustment interface 10 includes a list of control functions 11 that may be converted into hot zones and an existing hot zone. Control functions that may be realized in the existing hot zone include a character movement 12 and a camera rotation 13. The control functions that may be converted into hot zones refer to that controls corresponding to the control functions in the list of control functions 11 may be converted into hot zones.

By way of example, the terminal sets, in response to a function setting operation for the first hot zone, a control function corresponding to the first hot zone as a first control function. For example, as shown in FIG. 1(b), an aim control function is dragged to a hot zone where a control function of the character movement 12 is located, and a control function of the hot zone is set as the aim control function.

In an aspect, the terminal switches, in response to a function switching operation for the first hot zone, a control function corresponding to the first hot zone from a first control function to a second control function.

In an aspect, the first control function includes, but is not limited to, at least one of “fire”, “aim down sights”, “squat”, “aim”, “jump”, “lie down”, and “run”. This is not specifically limited in this disclosure.

In an aspect, the second control function includes, but is not limited to, at least one of “fire”, “aim down sights”, “squat”, “aim”, “jump”, “lie down”, and “run”. This is not specifically limited in this disclosure.

By way of example, the terminal determines, in response to a touch drag operation for a central region of the first hot zone, an adjusted location parameter of the first hot zone, and changes, according to the adjusted location parameter, the location parameter of the first hot zone from an original location parameter to the adjusted location parameter.

For example, the terminal determines, in response to a touch drag operation for a central region of the first hot zone, a drag direction of the central region of the first hot zone, a drag distance on an X axis, and a drag distance on a Y axis, so as to determine an adjusted location parameter of the first hot zone, and changes, according to the adjusted location parameter, the location parameter of the first hot zone from an original location parameter to the adjusted location parameter. For example, if the central region of the first hot zone is dragged upwards to the right, dragged by 200 px on the X axis, and dragged by 100 px on the Y axis, the first hot zone moves rightwards by 200 px and upwards by 100 px.

By way of example, the terminal determines, in response to a touch drag operation for at least one side region of the first hot zone, an adjusted size parameter of the first hot zone, and changes, according to the adjusted size parameter, the size parameter of the first hot zone from an original size parameter to the adjusted size parameter.

For example, the terminal determines, in response to a touch drag operation for at least one side region of the first hot zone, a drag direction of the at least one side region, a drag distance on an X axis, and a drag distance on a Y axis, so as to determine an adjusted size parameter of the first hot zone, and changes, according to the adjusted size parameter, the size parameter of the first hot zone from an original size parameter to the adjusted size parameter. For example, if a lower region of the first hot zone is dragged upwards by 240 px, the lower region of the first hot zone moves upwards by 240 px.

By way of example, the terminal displays, based on historical touch behavior data of the terminal, a recommended irregular hot zone on the hot zone adjustment interface of the game application.

In an aspect, the obtained historical touch behavior data is analyzed, at least one historical touch point triggered at a frequency greater than a frequency threshold is connected, and a recommended irregular hot zone is determined. The recommended irregular hot zone is displayed on the hot zone adjustment interface of the game application. The historical touch point refers to a touch region centered on a contact point.

In an aspect, the obtained historical touch behavior data is analyzed, the historical touch points overlapping within a range greater than an overlap threshold among historical touch points are connected, and the recommended irregular hot zone is determined. The recommended irregular hot zone is displayed on the hot zone adjustment interface of the game application.

In conclusion, according to the method provided by this aspect, a hot zone adjustment interface of a game application is displayed, and a custom operation for a first hot zone in at least one hot zone is received. In response to the custom operation for the first hot zone, at least one parameter of the first hot zone is customized. This disclosure provides a new method for customizing hot zones, which customizes and adjusts hot zones in a user interface, thereby avoiding the waste of space in the user interface, improving the convenience of operation, meeting the degree of freedom of needs of users for hot zones, and improving the user experience.

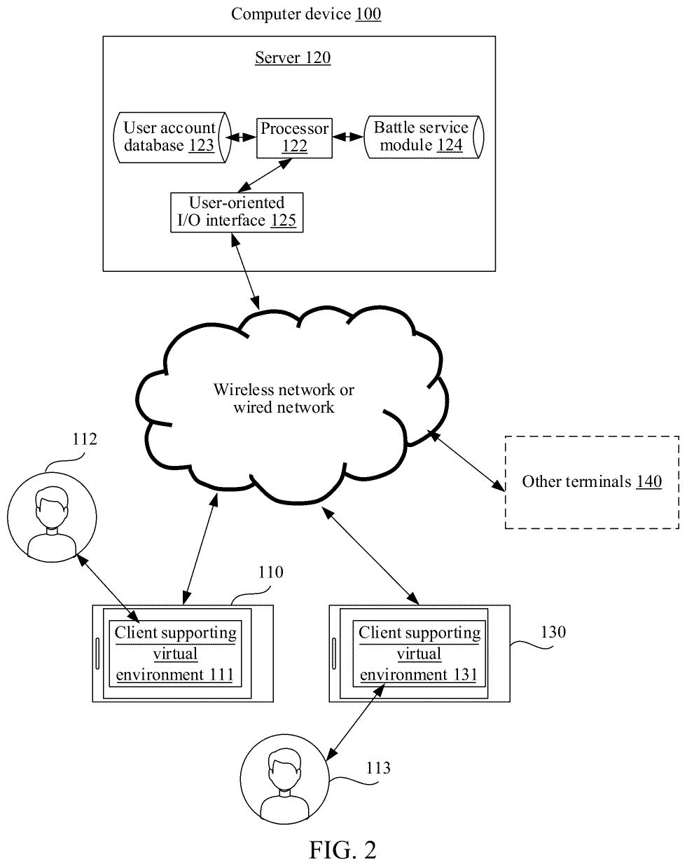

FIG. 2 shows a structural block diagram of a computer system according to an aspect of this disclosure. The computer system 100 includes: a first terminal 110, a server 120, and a second terminal 130.

A client 111 supporting a virtual environment is installed and run in the first terminal 110, and the client 111 may be a multiplayer online battle program. When the first terminal runs the client 111, a user interface of the client 111 is displayed on a screen of the first terminal 110. The client 111 may be any one of an escape shooting game, a virtual reality (VR) application, an augmented reality (AR) program, a three-dimensional map program, a virtual reality game, an augmented reality game, a first-person shooting (FPS) game, a third-personal shooting (TPS) game, a multiplayer online battle arena (MOBA) game, and a simulation game (SLG). This aspect is exemplified by the client 111 being an MOBA game. The first terminal 110 is a terminal used by a first user 112. The first user 112 uses the first terminal 110 to control activities of a first virtual character located in a virtual environment, or control a pet virtual character to explore in a virtual world. The first virtual character may be referred to as a virtual character of the first user 112. The first user 112 may perform operations such as assembling, disassembling, and uninstalling virtual items owned by the first virtual character. This is not limited in this disclosure. By way of example, the first virtual character is a first virtual character, such as a simulated character role or an animated character role.

A client 131 supporting a virtual environment is installed and run in the second terminal 130, and the client 131 may be a multiplayer online battle program. When the second terminal 130 runs the client 131, a user interface of the client 131 is displayed on a screen of the second terminal 130. The client may be any one of an escape shooting game, a VR application, an AR program, a three-dimensional map program, a virtual reality game, an augmented reality game, FPS, TPS, MOBA, and SLG. This aspect is exemplified by the client being an MOBA game. The second terminal 130 is a terminal used by a second user 113. The second user 113 uses the second terminal 130 to control activities of a second virtual character located in the virtual environment, or to control a pet virtual character to explore in a virtual world. The second virtual character may be referred to as a virtual character of the second user 113. By way of example, the second virtual character is a second virtual character, such as a simulated character role or an animated character role.

In some aspects, the first virtual character and the second virtual character are in the same virtual environment. In some aspects, the first virtual character and the second virtual character may belong to the same camp, the same team and the same organization, have a friend relationship, or have a temporary communication permission. In some aspects, the first virtual character and the second virtual character may belong to different camps, different teams and different organizations, or have an adversarial relationship.

In some aspects, the clients installed on the first terminal 110 and the second terminal 130 are the same, or the clients installed on the two terminals are the same type of clients on different operating system platforms (Android or IOS). The first terminal 110 may generally refer to one of a plurality of terminals, and the second terminal 130 may generally refer to another of the plurality of terminals. The first terminal 110 and the second terminal 130 have the same or different device types. The device types include: at least one of a smartphone, a tablet computer, an e-book reader, an MP3 player, an MP4 player, a laptop portable computer, and a desktop computer.

Two terminals are shown in FIG. 2. However, in an aspect, there are a plurality of other terminals 140 having access to the server 120. In some aspects, there are also one or more terminals 140 corresponding to a developer. A development and editing platform for a client supporting the virtual environment is installed on the terminal 140. The developer may edit and update the client on the terminal 140, and transmit an updated client installation package to the server 120 through a wired or wireless network. The first terminal 110 and the second terminal 130 may download the client installation package from the server 120 to implement the update of the client.

The first terminal 110, the second terminal 130, and the other terminals 140 are connected to the server 120 through the wireless network or the wired network.

The server 120 includes at least one of a server, multiple servers, a cloud computing platform, and a virtualization center. The server 120 is configured to provide a background service for the client supporting the three-dimensional virtual environment. In some aspects, the server 120 undertakes primary computing tasks, and the terminal undertakes secondary computing tasks. Or, the server 120 undertakes secondary computing tasks, and the terminal undertakes primary computing tasks. Or, the server 120 and the terminal perform cooperative computing using a distributed computing architecture.

In a schematic example, the server 120 includes a processor 122, a user account database 123, a battle service module 124, and a user-oriented input/output (I/O) interface 125. The processor 122 is configured to load an instruction stored in the server 121 and process data in the user account database 123 and the battle service module 124. The user account database 123 is configured to store data of a user account used by the first terminal 110, the second terminal 130 and the other terminals 140, such as a head portrait of the user account, a nickname of the user account, a combat effectiveness index of the user account, and a service region where the user account is located. The battle service module 124 is configured to provide a plurality of battle rooms for users to battle, such as a 1V1 battle, a 3V3 battle, or a 5V5 battle. The user-oriented I/O interface 125 is configured to communicate data with the first terminal 110 and/or the second terminal 130 through the wireless network or the wired network.

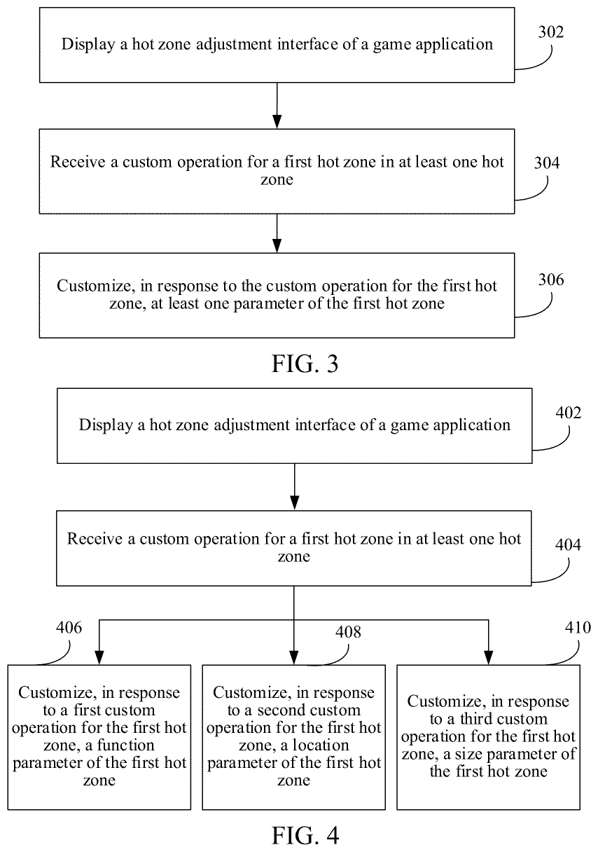

FIG. 3 is a flowchart of a hot zone adjustment method according to an aspect of this disclosure. The method may be performed by a terminal or a client on the terminal in a system as shown in FIG. 2. The method includes the following operations:

Operation 302: Display a hot zone adjustment interface of a game application.

The hot zone adjustment interface refers to a display interface of an application of the game application. The hot zone adjustment interface is configured for adjusting the at least one hot zone.

The hot zone is a touch control region for executing a control function of a virtual character and the hot zone does not have a control display form.

The virtual character is configured for moving in a virtual world provided by the game application.

In some aspects, for a first hot zone in the at least one hot zone, by triggering the first hot zone, a control function corresponding to the first hot zone may be realized. Namely, different hot zones may correspond to different control functions. By way of example, in a shooting game type application, the at least one hot zone may include a hot zone for controlling a direction (such as an operation hot zone), a hot zone for casting a skill (such as a skill hot zone), and a hot zone for setting a user interface (such as a setting hot zone). This disclosure does not limit the type of the hot zone.

The hot zone may be displayed in a visible or invisible form. By way of example, the control function text or icon of the hot zone may be visibly displayed on a partial location of a region where the hot zone is located, or the hot zone may be visibly displayed in a translucent mode. The hot zone may also be displayed in a transparent mode, namely, in an invisible form.

Operation 304: Receive a custom operation for a first hot zone in the at least one hot zone.

The custom operation refers to an operation of adjusting the hot zone according to operating habits and strategic arrangements of players.

The first hot zone refers to any hot zone in the at least one hot zone. In some aspects (such as a shooting game type application), in a case that a certain type of hot zone (such as a setting hot zone) does not affect a user operation or is not used to perform a control function of a virtual character, the first hot zone may refer to any hot zone other than this type of hot zone.

By way of example, the custom operation may be obtained as follows: obtaining a custom operation for the first hot zone in response to an operation for the first hot zone in the hot zone adjustment interface.

Operation 306: Customize, in response to the custom operation for the first hot zone, at least one parameter of the first hot zone.

The at least one parameter of the first hot zone includes, but is not limited to, at least one of a function parameter, a size parameter, a location parameter, and a shape parameter. This is not specifically limited in this disclosure.

For example, taking the size parameter of the first hot zone as an example, the first hot zone is increased or decreased by triggering the dragging of a side region of the first hot zone. Or, a size increase button and a size decrease button are configured, and the size of the first hot zone is increased in response to a click operation for the size increase button. Or, a size adjustment sliding block is configured, and the size of the first hot zone is adjusted in response to a sliding operation for the size adjustment sliding block. This disclosure does not limit a specific implementation of the custom operation, which may be adjusted according to actual use requirements.

In conclusion, according to the method provided by this aspect, a hot zone adjustment interface of a game application is displayed, and a custom operation for a first hot zone in at least one hot zone is received. In response to the custom operation for the first hot zone, at least one parameter of the first hot zone is customized. This disclosure provides a new method for customizing hot zones, which customizes and adjusts hot zones in a user interface, thereby avoiding the waste of space in the user interface caused by gaps between operation controls of a fixed shape, improving the convenience of operation, meeting the degree of freedom of needs of users for hot zones, and improving the user experience.

FIG. 4 is a flowchart of a hot zone adjustment method according to an aspect of this disclosure. The method may be performed by a terminal or a client on the terminal in a system as shown in FIG. 2. The method includes the following operations:

Operation 402: Display a hot zone adjustment interface of a game application.

The hot zone adjustment interface refers to a display interface of an application of the game application. The hot zone adjustment interface is configured for adjusting the at least one hot zone.

The hot zone is a touch control region for executing a control function of a virtual character and the hot zone does not have a control display form.

The virtual character is configured for moving in a virtual world provided by the game application.

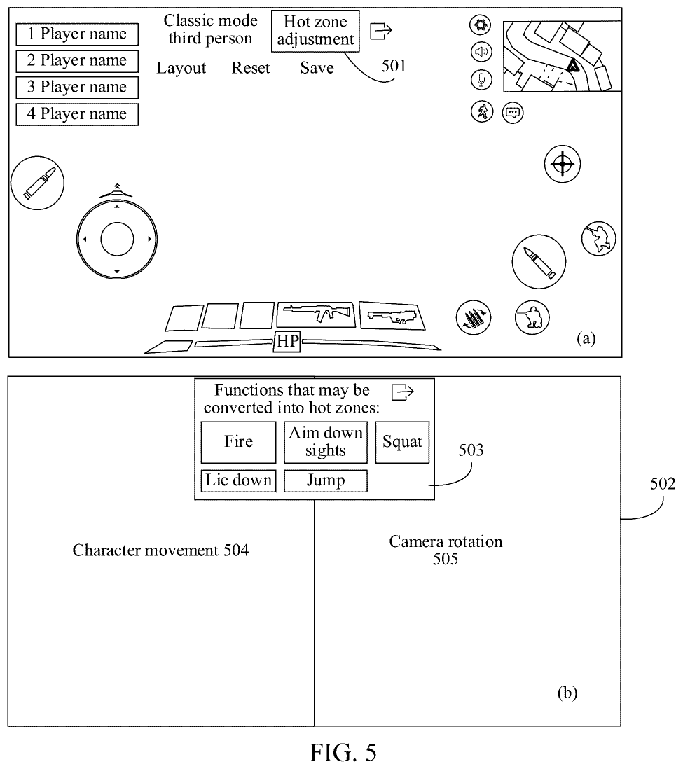

By way of example, FIG. 5 shows a schematic diagram of a hot zone adjustment method. FIG. 5(a) illustrates a schematic diagram of a virtual environment picture. The virtual environment picture is configured for presenting a virtual environment of a game battle to a user in a shooting game type application. The virtual environment picture includes a display layer and a control layer. The display layer is configured to display the virtual environment picture. The control layer is configured to display controls (such as operation controls and setting controls). By triggering a hot zone adjustment control 501, a hot zone adjustment interface 502 is displayed. As shown in FIG. 5(b), the hot zone adjustment interface 502 includes a list of control functions 503 that may be converted into hot zones and an existing hot zone. Control functions that may be realized in the existing hot zone include a character movement 504 and a camera rotation 505. The control functions that may be converted into hot zones refer to that controls corresponding to the control functions in the list of control functions 503 may be converted into hot zones. By way of example, a camera rotating in the control function is also referred to as a virtual camera. A camera model points to a shooting direction perpendicular to an imaging plane. The imaging plane is generally rectangular, also referred to as an imaging rectangle. Virtual photosensitive elements on the imaging plane are in one-to-one correspondence with pixels on a terminal screen, and the virtual photosensitive elements record light intensity and color when the virtual character is observed by the camera model.

In a possible implementation, operation 402 is implementable into: displaying, based on historical touch behavior data of the terminal, a recommended irregular hot zone on the hot zone adjustment interface of the game application.

In some aspects, a recommended irregular hot zone is displayed on the hot zone adjustment interface of the game application based on historical touch behavior data of the terminal. In a case that there are controls in the recommended irregular hot zone, corresponding regions of the controls are eliminated to obtain an irregular hot zone that does not contain the corresponding regions of the controls.

In some aspects, the obtained historical touch behavior data is analyzed, at least one historical touch point triggered at a frequency greater than a frequency threshold is connected, and a recommended irregular hot zone is determined. The recommended irregular hot zone is displayed on the hot zone adjustment interface of the game application. The historical touch point refers to a touch region centered on a contact point.

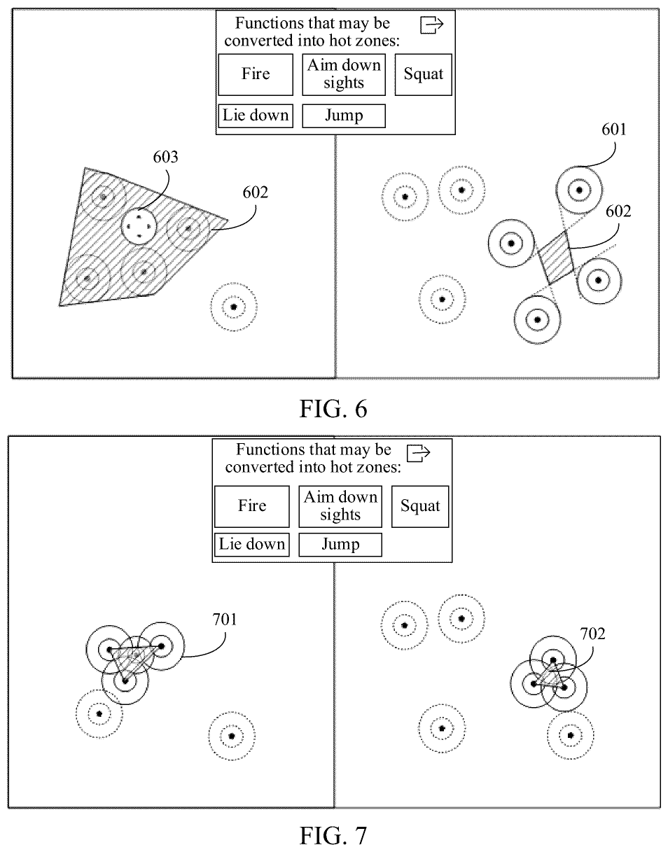

By way of example, FIG. 6 shows a schematic diagram of a hot zone. A circle in the figure is a historical touch point 601. The historical touch behavior data of the terminal is obtained and analyzed. At least two historical touch points 601 triggered at a frequency greater than a frequency threshold are used as historical touch points 601 for connection, and a region surrounded by the at least two historical touch points 601 for connection is determined as a recommended irregular hot zone 602.

In an example, as shown in a left-hand view in FIG. 6, the terminal determines external common tangents of any two historical touch points 601 for connection based on the principle of maximum area, and determines a maximum region surrounded by the external common tangents as the recommended irregular hot zone 602 with the maximum area.

The principle of maximum area refers to the principle that the maximum area is surrounded by external common tangent points of at least two circle regions.

In an example, as shown in a right-hand view in FIG. 6, the terminal determines common tangents of any two historical touch points 601 for connection based on the principle of minimum area, and determines a minimum region surrounded by the common tangents as the recommended irregular hot zone 602 with the minimum area.

The principle of minimum area refers to the principle that the minimum area is surrounded by common tangent points of at least two circles. Common tangents in the principle of minimum area include external common tangents and/or internal common tangents.

In an example, the terminal takes centers of the historical touch points 601 for connection as connection points, and determines a region surrounded by the centers of the historical touch points 601 as the recommended irregular hot zone 602 by connecting the connection points on the historical touch points 601 for connection.

In an example, in a case that the terminal determines a region surrounded by at least two historical touch points 601 for connection as the recommended irregular hot zone 602 and there is a control 603 in the recommended irregular hot zone 602, a corresponding region of the control 603 is eliminated to obtain the irregular hot zone 602 that does not contain the corresponding region of the control 603.

In an example, the obtained historical touch behavior data is analyzed, the historical touch points overlapping within a range greater than an overlap threshold among historical touch points are connected, and the recommended irregular hot zone is determined. The recommended irregular hot zone is displayed on the hot zone adjustment interface of the game application.

By way of example, FIG. 7 shows a schematic diagram of a hot zone. A circle in the figure is a historical touch point 701. The historical touch behavior data of the terminal is obtained and analyzed. The historical touch points 701 overlapping within a range greater than an overlap threshold among the historical touch points are connected, and a region surrounded by the at least two historical touch points 701 is determined as a recommended irregular hot zone 702. For example, touch points overlapping within a range greater than two-fifths of the area of the historical touch points 701 among the historical touch points are determined as historical touch points for connection, and the historical touch points for connection are connected to obtain a region which is determined as the recommended irregular hot zone 702.

In some aspects, the terminal determines external common tangents of any two historical touch points 701 for connection based on the principle of maximum area, and determines a maximum region surrounded by the external common tangents as the recommended irregular hot zone 702.

The principle of maximum area refers to the principle that the maximum area is surrounded by external common tangent points of at least two circle regions.

In some aspects, the terminal determines common tangents of any two historical touch points 701 for connection based on the principle of minimum area, and determines a minimum region surrounded by the common tangents as the recommended irregular hot zone 702.

The principle of minimum area refers to the principle that the minimum area is surrounded by common tangent points of at least two circle regions. Common tangents in the principle of minimum area include external common tangents and/or internal common tangents.

In some aspects, as shown in FIG. 7, the terminal takes centers of the historical touch points 701 for connection as connection points, and determines a region surrounded by the centers of the historical touch points 701 as the recommended irregular hot zone 702 by connecting the connection points on the historical touch points 701 for connection.

Operation 404: Receive a custom operation for a first hot zone in the at least one hot zone.

The custom operation refers to an operation of adjusting the hot zone according to operating habits and strategic arrangements of players.

The first hot zone refers to any hot zone in the at least one hot zone. In some aspects (such as a shooting game type application), in a case that a certain type of hot zone (such as a setting hot zone) does not affect a user operation or is not used to perform a control function of a virtual character, the first hot zone may refer to any hot zone other than this type of hot zone.

By way of example, the custom operation may be obtained as follows: obtaining a custom operation for the first hot zone in response to an operation for the first hot zone in the hot zone adjustment interface.

Operation 406: Customize, in response to a first custom operation for the first hot zone, a function parameter of the first hot zone.

The function parameter of the first hot zone refers to a control function corresponding to the first hot zone.

The first custom operation refers to an operation of setting the function parameter of the first hot zone, namely, determining the control function corresponding to the first hot zone.

In an optional implementation, operation 406 is implementable into that: the terminal sets, in response to a function setting operation for the first hot zone, a control function corresponding to the first hot zone as a first control function.

In some aspects, the first control function includes, but is not limited to, at least one of “fire”, “aim down sights”, “squat”, “aim”, “jump”, “lie down”, and “run”. This is not specifically limited in this disclosure.

For example, the control function of the first hot zone is set as an aim control function, and a control function of a second hot zone is set as a fire control function. By triggering any location of the first hot zone, the virtual character is controlled to execute an aim action. By triggering any location of the second hot zone, the virtual character is controlled to execute a fire action.

In an example, operation 406 is implementable into that: the terminal switches, in response to a function switching operation for the first hot zone, a control function corresponding to the first hot zone from a first control function to a second control function.

In some aspects, the second control function includes, but is not limited to, at least one of “fire”, “aim down sights”, “squat”, “aim”, “jump”, “lie down”, and “run”. This is not specifically limited in this disclosure.

For example, the control function of the first hot zone is set as an aim control function. The terminal switches, in response to a function switching operation for the first hot zone, the aim control function of the first hot zone to a fire control function. Then, by triggering any location of the first hot zone, the virtual character is controlled to execute a fire action.

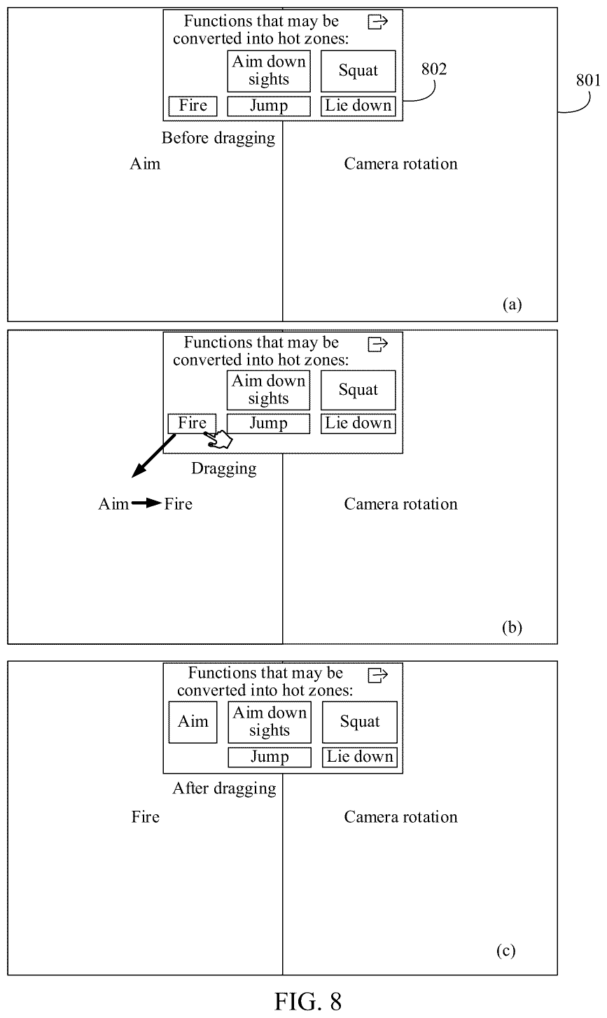

For example, FIG. 8 shows a schematic diagram of a hot zone adjustment interface. As shown in FIG. 8(a), a hot zone adjustment interface 801 of a game application is displayed in a terminal. The hot zone adjustment interface 801 includes a list of control functions 802 that may be converted into hot zones, a first hot zone, and a second hot zone. A control function that may be realized in the first hot zone is an “aim” control function, and the control function that may be realized in the first hot zone is “camera rotation”. As shown in FIG. 8(b), the terminal drags, in response to a function switching operation for the first hot zone, a “fire” control function in the list of control functions 802 to the first hot zone, and switches the “aim” control function of the first hot zone to the “fire” control function. As shown in FIG. 8(c), the “aim” control function of the first hot zone is switched to the “fire” control function. The “fire” control function in the list of control functions 802 is canceled, and the “aim” control function is added.

Operation 408: Customize, in response to a second custom operation for the first hot zone, a location parameter of the first hot zone.

The second custom operation refers to an operation of setting the location parameter of the first hot zone, namely, determining a location corresponding to the first hot zone. In an optional implementation, operation 408 is implementable into that: the terminal determines, in response to a touch drag operation for a central region of the first hot zone, an adjusted location parameter of the first hot zone, and changes, according to the adjusted location parameter, the location parameter of the first hot zone from an original location parameter to the adjusted location parameter.

For example, the terminal determines, in response to a touch drag operation for a central region of the first hot zone, a drag direction of the central region of the first hot zone, a drag distance on an X axis, and a drag distance on a Y axis, so as to determine an adjusted location parameter of the first hot zone, and changes, according to the adjusted location parameter, the location parameter of the first hot zone from an original location parameter to the adjusted location parameter. For example, if the central region of the first hot zone is dragged upwards to the right, dragged by 200 px on the X axis, and dragged by 100 px on the Y axis, the first hot zone moves rightwards by 200 px and upwards by 100 px.

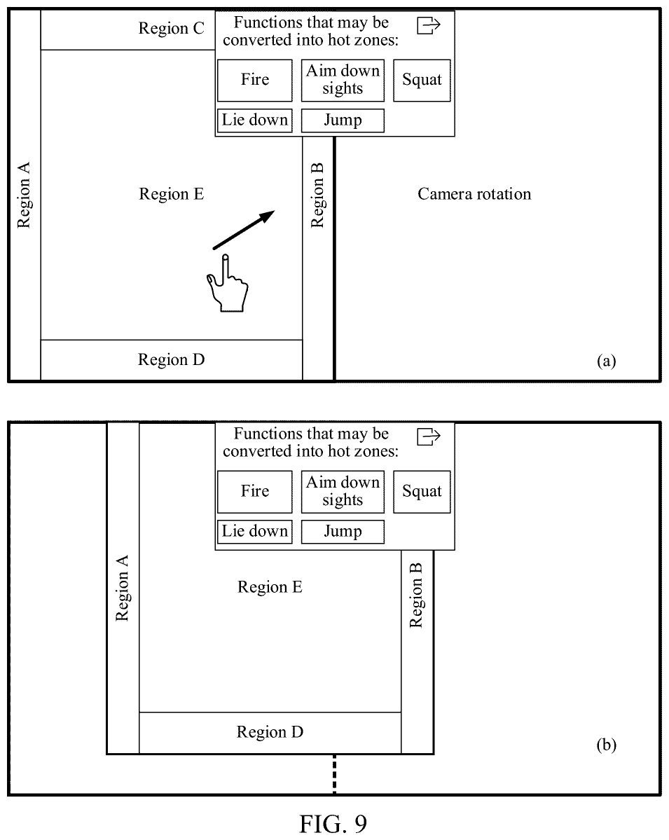

For example, FIG. 9 shows a schematic diagram of a hot zone adjustment interface. The first hot zone is divided into five regions, namely, a central region (region E), a left region (region A), a right region (region B), an upper region (region C), and a lower region (region D). The heights of the left region and the right region are the height of the first hot zone, and the widths of the left region and the right region are 5% of the width of the first hot zone. The heights of the upper region and the lower region are 5% of the height of the first hot zone, and the widths of the upper region and the lower region are 90% of the width of the first hot zone. The width of the central region is 90% of the width of the first hot zone, and the height of the central region is 90% of the height of the first hot zone. The terminal determines, in response to a touch drag operation for a central region of the first hot zone, an adjusted location parameter of the first hot zone according to a drag direction of the central region, a drag distance on an X axis, and a drag distance on a Y axis, and changes, according to the adjusted location parameter, the location parameter of the first hot zone from an original location parameter to the adjusted location parameter.

Operation 410: Customize, in response to a third custom operation for the first hot zone, a size parameter of the first hot zone.

The third custom operation refers to an operation of setting the size parameter of the first hot zone, namely, determining a size corresponding to the first hot zone.

In an optional implementation, operation 410 is implementable into that: the terminal determines, in response to a touch drag operation for at least one side region of the first hot zone, an adjusted size parameter of the first hot zone, and changes, according to the adjusted size parameter, the size parameter of the first hot zone from an original size parameter to the adjusted size parameter.

For example, the terminal determines, in response to a touch drag operation for at least one side region of the first hot zone, a drag direction of the at least one side region, a drag distance on an X axis, and a drag distance on a Y axis, so as to determine an adjusted size parameter of the first hot zone, and changes, according to the adjusted size parameter, the size parameter of the first hot zone from an original size parameter to the adjusted size parameter. For example, if a lower region of the first hot zone is dragged upwards by 240 px, the lower region of the first hot zone moves upwards by 240 px.

In some aspects, the operation that the terminal determines, in response to a touch drag operation for at least one side region of the first hot zone, an adjusted size parameter of the first hot zone includes at least one of the following conditions:
The terminal determines, in response to a touch drag operation for the lower region of the first hot zone, an adjusted size parameter of the first hot zone according to a drag direction of the lower region and the drag distance on the Y axis.
The terminal determines, in response to a touch drag operation for the upper region of the first hot zone, an adjusted size parameter of the first hot zone according to a drag direction of the upper region and the drag distance on the Y axis.
The terminal determines, in response to a touch drag operation for the left region of the first hot zone, an adjusted size parameter of the first hot zone according to a drag direction of the left region and the drag distance on the X axis.
The terminal determines, in response to a touch drag operation for the right region of the first hot zone, an adjusted size parameter of the first hot zone according to a drag direction of the right region and the drag distance on the X axis.

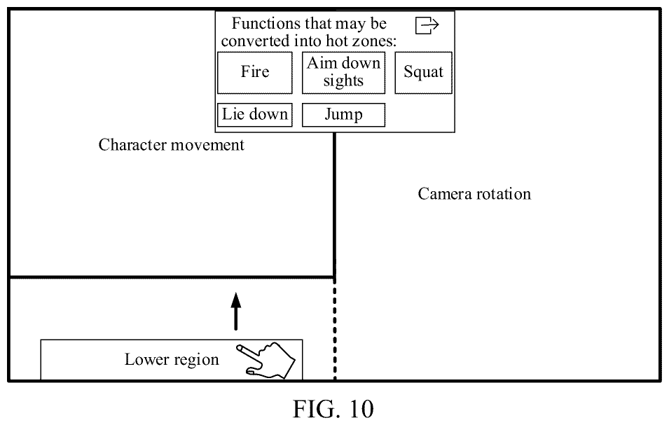

For example, FIG. 10 shows a schematic diagram of a hot zone adjustment interface. The terminal determines, in response to the touch drag operation for the lower region of the first hot zone, an adjusted size parameter of the first hot zone according to the drag direction of the lower region and the drag distance on the Y axis, and changes, according to the adjusted size parameter, the size parameter of the first hot zone from an original size parameter to the adjusted size parameter.

In some aspects, the type of the custom operation for the size parameter of the first hot zone includes at least one of the following modes:
Increase or decrease the first hot zone by triggering the dragging of a side region of the first hot zone.
Configure a size increase button and a size decrease button, and increase the size of the first hot zone in response to a click operation for the size increase button.
Configure a size adjustment sliding block, and adjust the size of the first hot zone in response to a sliding operation for the size adjustment sliding block.

This disclosure does not limit the type of the custom operation, which may be adjusted according to actual use requirements.

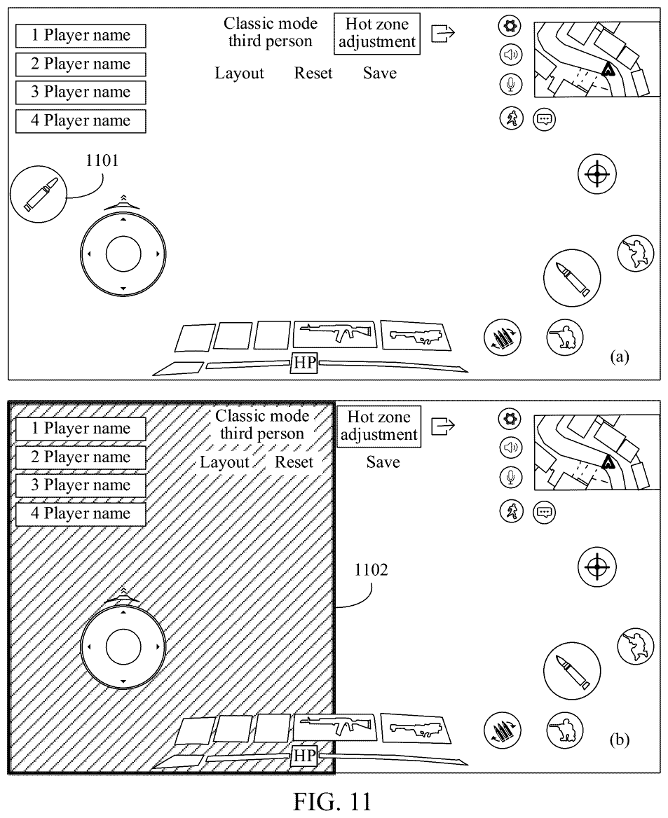

By way of example, FIG. 11 shows a schematic diagram of a hot zone adjustment method. FIG. 11(a) illustrates a schematic diagram of a virtual environment picture. The virtual environment picture is configured for presenting a virtual environment of a game battle to a user in a shooting game type application. The virtual environment picture includes a display layer and a control layer. The display layer is configured to display the virtual environment picture. The control layer is configured to display controls (such as operation controls and setting controls). By adjusting the hot zone, a fire control 1101 is converted into a hot zone 1102. As shown in FIG. 11(b), the fire control 1101 in the display and control layers is canceled, and the hot zone 1102 with a “fire” control function is added. Namely, any location in the hot zone 1102 is triggered, and the “fire” control function may be realized.

In some aspects, the hot zone is presented in a visible mode, or in an invisible mode. This is not specifically limited in this disclosure.

In an example, any one or any two of operations 406, 408, and 410 can be combined with operations 402 and 404 into a new operation to be implemented alone. This is not limited in this disclosure.

In conclusion, according to the method provided by this aspect, a hot zone adjustment interface of a game application is displayed, and a custom operation for a first hot zone in at least one hot zone is received. In response to the custom operation for the first hot zone, a function parameter, a location parameter, and a size parameter of the first hot zone are customized. This disclosure provides a new method for customizing hot zones, which customizes and adjusts hot zones in a user interface, thereby avoiding the waste of space in the user interface caused by gaps between operation controls of a fixed shape, improving the convenience of operation, meeting the degree of freedom of needs of users for hot zones, and improving the user experience.

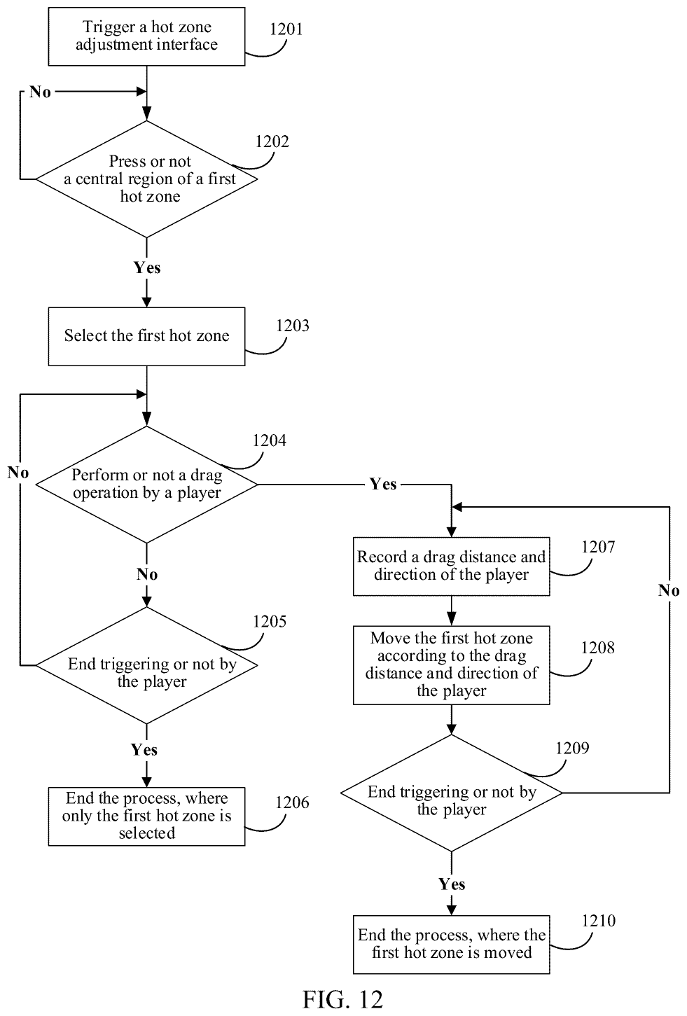

FIG. 12 is a flowchart of a hot zone adjustment method according to an aspect of this disclosure. The method may be performed by a terminal or a client on the terminal in a system as shown in FIG. 2. The method includes the following operations:

Operation 1201: Trigger a hot zone adjustment interface.

By way of example, the hot zone adjustment interface refers to a display interface of an application of a game application. The hot zone adjustment interface is configured for adjusting at least one hot zone. The hot zone is a touch control region for executing a control function of a virtual character and the hot zone does not have a control display form.

Operation 1202: Press or not a central region of a first hot zone.

By way of example, in a case that a player triggers a hot zone, it is determined whether the player presses the central region of the first hot zone. In a case that the player presses the central region of the first hot zone, operation 1203 is performed.

Operation 1203: Select the first hot zone.

By way of example, in a case that the player presses the central region of the first hot zone, the first hot zone is selected.

Operation 1204: Perform or not a drag operation by a player.

By way of example, in a case that the player presses the central region of the first hot zone and selects the first hot zone, it is determined whether the player drags the first hot zone. In a case that the player drags the first hot zone, operation 1207 is performed. In a case that the player does not drag the first hot zone, operation 1205 is performed.

Operation 1205: End triggering or not by the player.

By way of example, in a case that the player does not drag the first hot zone, it is determined whether the player ends triggering, namely, lifts the finger. In a case that the player still triggers the first hot zone, operation 1204 is performed. In a case that the player ends triggering the first hot zone, operation 1206 is performed.

Operation 1206: End the process, where the first hot zone is selected.

Operation 1207: Record a drag distance and direction of the player.

By way of example, in a case that the player drags the first hot zone, a distance and direction of dragging the first hot zone by the player are recorded.

Operation 1208: Move the first hot zone according to the drag distance and direction of the player.

By way of example, an adjusted location parameter of the first hot zone is determined according to the distance and direction of dragging the first hot zone by the player. The location parameter of the first hot zone is changed from an original location parameter to the adjusted location parameter according to the adjusted location parameter.

Operation 1209: End triggering or not by the player.

By way of example, in a case that the player does not drag the first hot zone, it is determined whether the player ends triggering, namely, lifts the finger. In a case that the player still triggers the first hot zone, operation 1207 is performed. In a case that the player ends triggering the first hot zone, operation 1210 is performed.

Operation 1210: End the process, where the first hot zone is moved.

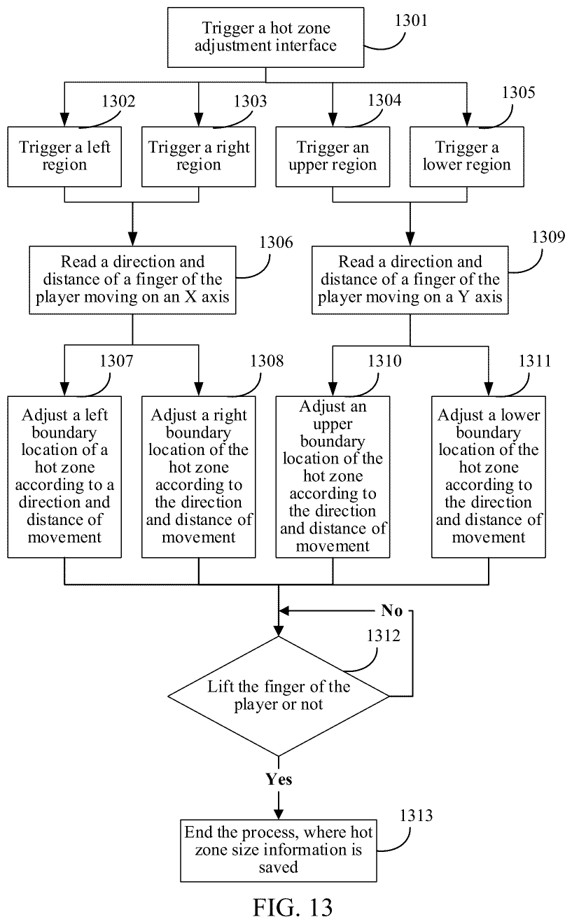

FIG. 13 is a flowchart of a hot zone adjustment method according to an aspect of this disclosure. The method may be performed by a terminal or a client on the terminal in a system as shown in FIG. 2. The method includes the following operations:

Operation 1301: Trigger a hot zone adjustment interface.

By way of example, the hot zone adjustment interface refers to a display interface of an application of a game application. The hot zone adjustment interface is configured for adjusting at least one hot zone. The hot zone is a touch control region for executing a control function of a virtual character and the hot zone does not have a control display form.

Operation 1302: Trigger a left region.

By way of example, in a case that the player triggers the left region of the first hot zone, operation 1306 is performed.

Operation 1303: Trigger a right region.

By way of example, in a case that the player triggers the right region of the first hot zone, operation 1306 is performed.

Operation 1304: Trigger an upper region.

By way of example, in a case that the player triggers the upper region of the first hot zone, operation 1309 is performed.

Operation 1305: Trigger a lower region.

By way of example, in a case that the player triggers the lower region of the first hot zone, operation 1309 is performed.

Operation 1306: Read a direction and distance of a finger of the player moving on an X axis.

By way of example, in a case that the player triggers the left region and/or the right region of the first hot zone, the direction and distance of the finger of the player moving on the X axis are read.

Operation 1307: Adjust a left boundary location of a hot zone according to a direction and distance of movement.

By way of example, in a case that the player triggers the left region of the first hot zone, the direction and distance of the finger of the player moving on the X axis are read, and a left boundary location of the first hot zone is adjusted according to the direction and distance of the finger of the player moving on the X axis.

Operation 1308: Adjust a right boundary location of the hot zone according to the direction and distance of movement.

By way of example, in a case that the player triggers the right region of the first hot zone, the direction and distance of the finger of the player moving on the X axis are read, and a right boundary location of the first hot zone is adjusted according to the direction and distance of the finger of the player moving on the X axis.

Operation 1309: Read a direction and distance of a finger of the player moving on a Y axis.

By way of example, in a case that the player triggers the upper region and/or the lower region of the first hot zone, the direction and distance of the finger of the player moving on the Y axis are read.

Operation 1310: Adjust an upper boundary location of the hot zone according to the direction and distance of movement.

By way of example, in a case that the player triggers the upper region of the first hot zone, the direction and distance of the finger of the player moving on the Y axis are read, and an upper boundary location of the first hot zone is adjusted according to the direction and distance of the finger of the player moving on the Y axis.

Operation 1311: Adjust a lower boundary location of the hot zone according to the direction and distance of movement.

By way of example, in a case that the player triggers the lower region of the first hot zone, the direction and distance of the finger of the player moving on the Y axis are read, and a lower boundary location of the first hot zone is adjusted according to the direction and distance of the finger of the player moving on the Y axis.

Operation 1312: Lift the finger of the player or not.

By way of example, in a case that the player ends triggering, operation 1313 is performed.

Operation 1313: End the process, where hot zone size information is saved.

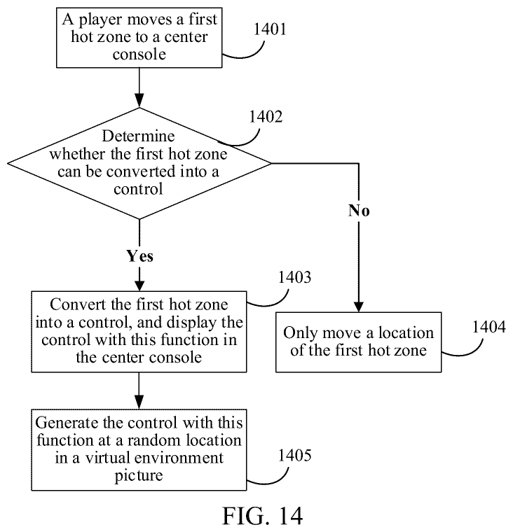

FIG. 14 is a flowchart of a hot zone adjustment method according to an aspect of this disclosure. The method may be performed by a terminal or a client on the terminal in a system as shown in FIG. 2. The method includes the following operations:

Operation 1401: A player moves a first hot zone to a center console.

By way of example, a hot zone adjustment interface of a game application is displayed in a terminal. The hot zone adjustment interface includes a center console. A list of control functions that may be converted into hot zones is displayed in the center console.

Operation 1402: Determine whether the first hot zone can be converted into a control.

By way of example, it is determined whether the first hot zone selected currently can be converted into a control with a corresponding function. In a case that the first hot zone selected currently can be converted into the control with the corresponding function, operation 1403 is performed. In a case that the first hot zone selected currently cannot be converted into the control with the corresponding function, operation 1404 is performed.

Operation 1403: Convert the first hot zone into a control, and display the control with this function in the center console.

By way of example, in a case that the first hot zone selected currently can be converted into the control with the corresponding function, the first hot zone is dragged to the center console, the first hot zone can be converted into the control with the corresponding function, and the control with this function is displayed in the center console.

Operation 1404: Move a location of the first hot zone.

By way of example, in a case that the first hot zone selected currently cannot be converted into the control with the corresponding function, the first hot zone is dragged to the center console, and the location of the first hot zone is moved.

Operation 1405: Generate the control with this function at a random location in a virtual environment picture.

By way of example, in a case that the first hot zone selected currently can be converted into the control with the corresponding function, the control with this function is displayed in the center console and displayed at the random location in the virtual environment picture.

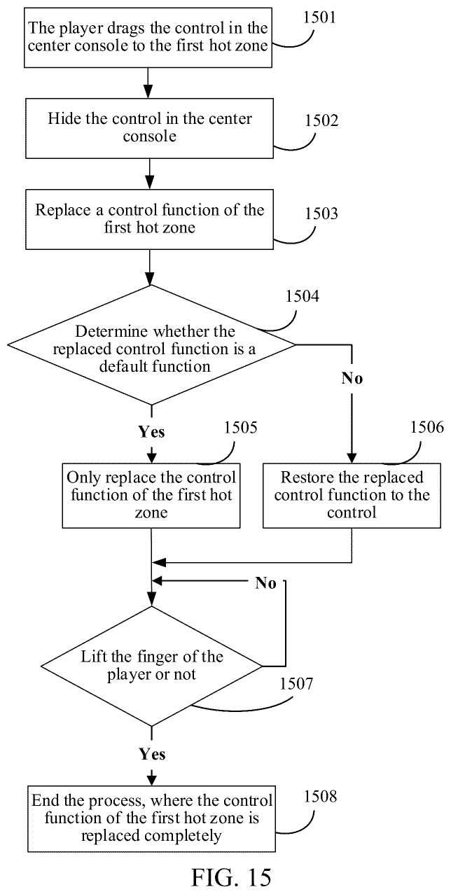

FIG. 15 is a flowchart of a hot zone adjustment method according to an aspect of this disclosure. The method may be performed by a terminal or a client on the terminal in a system as shown in FIG. 2. The method includes the following operations:

Operation 1501: A player drags a control in a center console to a first hot zone.

By way of example, a hot zone adjustment interface of a game application is displayed in a terminal. The hot zone adjustment interface includes a center console. A list of control functions that may be converted into hot zones is displayed in the center console. The player drags the control in the center console to the first hot zone.

Operation 1502: Hide the control in the center console.

By way of example, in a case that the player drags the control in the center console to the first hot zone, the control is hidden in the center console.

Operation 1503: Replace a control function of the first hot zone.

By way of example, in a case that the player drags the control in the center console to the first hot zone, the control function of the first hot zone is replaced with a control function corresponding to the control.

Operation 1504: Determine whether the replaced control function is a default function.

By way of example, it is determined whether the control function of the first hot zone is a default control function. In a case that the control function of the first hot zone is a default control function, operation 1505 is performed. In a case that the control function of the first hot zone is not a default control function, operation 1506 is performed.

Operation 1505: Replace the control function of the first hot zone.

By way of example, in a case that the control function of the first hot zone is a default control function, the control function of the first hot zone is replaced with the control function corresponding to the control.

Operation 1506: Restore the replaced control function to the control.

By way of example, in a case that the control function of the first hot zone is not a default control function, the control function of the first hot zone is replaced with the control function corresponding to the control. At the same time, the control function of the first hot zone is restored to a control corresponding to the control function.

For example, the control function of the first hot zone is an aim control function. The terminal switches, in response to a function switching operation for the first hot zone, the aim control function of the first hot zone to a fire control function. At the same time, the aim control function of the first hot zone is restored to a control corresponding to the aim control function.

Operation 1507: Lift the finger of the player or not.

By way of example, in a case that the player ends triggering, operation 1508 is performed.

Operation 1508: End the process, where the control function of the first hot zone is replaced completely.

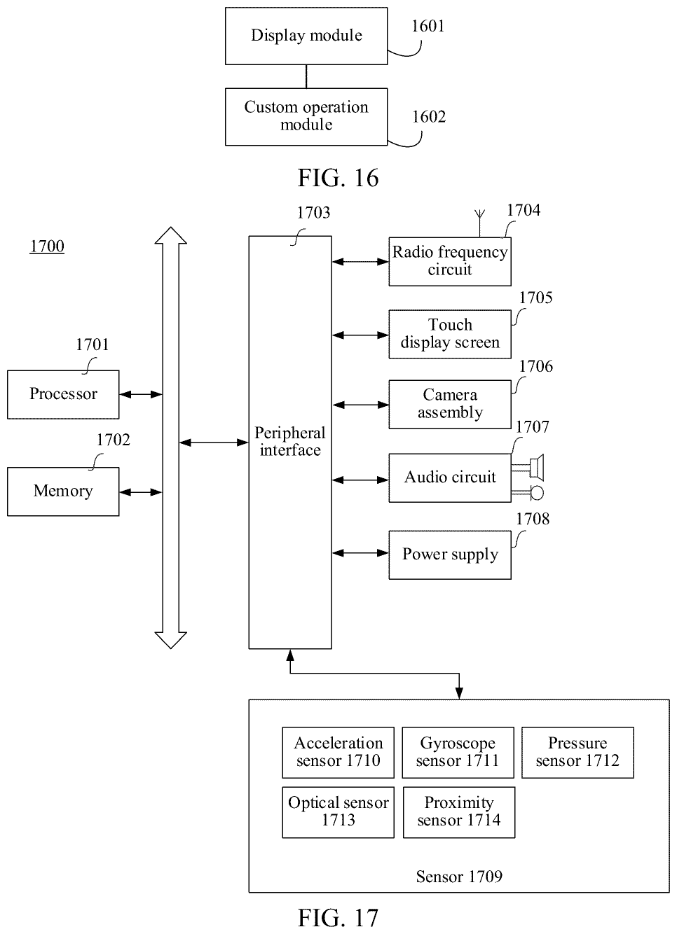

FIG. 16 shows a schematic structural diagram of a hot zone adjustment apparatus according to an aspect of this disclosure. The apparatus may be implemented in software, hardware or a combination of both as all or part of a computer device. The apparatus includes:
a display module 1601, configured to perform operation 302 in the aspect of FIG. 3; and
a custom operation module 1602, configured to perform operation 304 in the aspect of FIG. 3.

The custom operation module 1602 is configured to perform operation 306 in the aspect of FIG. 3.

In an example, the custom operation module 1602 is configured to perform operation 406 in the aspect of FIG. 4.

In an example, the custom operation module 1602 is configured to perform operation 408 in the aspect of FIG. 4.

In an example, the custom operation module 1602 is configured to perform operation 410 in the aspect of FIG. 4.

In an example, the custom operation module 1602 is configured to set, in response to a function setting operation for the first hot zone, a control function corresponding to the first hot zone as a first control function.

In an example, the custom operation module 1602 is configured to switch, in response to a function switching operation for the first hot zone, a control function corresponding to the first hot zone from a first control function to a second control function.

In an example, the custom operation module 1602 is configured to: determine, in response to a touch drag operation for a central region of the first hot zone, an adjusted location parameter of the first hot zone; and change, according to the adjusted location parameter, the location parameter of the first hot zone from an original location parameter to the adjusted location parameter.

In an example, the custom operation module 1602 is configured to: determine, in response to a touch drag operation for at least one side region of the first hot zone, an adjusted size parameter of the first hot zone; and change, according to the adjusted size parameter, the size parameter of the first hot zone from an original size parameter to the adjusted size parameter.

In an example, the display module 1601 is configured to display, based on historical touch behavior data of the terminal, a recommended irregular hot zone on the hot zone adjustment interface of the game application.

In an example, the display module 1601 is configured to: analyze the obtained historical touch behavior data, connect at least one historical touch point triggered at a frequency greater than a frequency threshold, and determine a recommended irregular hot zone; and display the recommended irregular hot zone on the hot zone adjustment interface of the game application.

The historical touch point refers to a touch region centered on a contact point.

In an example, the display module 1601 is configured to: analyze the obtained historical touch behavior data, connect, among historical touch points, the historical touch points overlapping within a range greater than an overlap threshold, and determine the recommended irregular hot zone; and display the recommended irregular hot zone on the hot zone adjustment interface of the game application.

The historical touch point refers to a touch region centered on a contact point.

In an example, the display module 1601 is configured to: obtain a tilt angle and a tilt direction of the terminal; and display, based on the tilt angle and the tilt direction, the at least one offset hot zone on the hot zone adjustment interface of the game application.

In an example, the display module 1601 is configured to: determine an offset distance of the at least one hot zone based on the tilt angle; determine an offset direction of the at least one hot zone based on the tilt direction; and display, based on the offset distance and the offset direction, the at least one offset hot zone on the hot zone adjustment interface of the game application.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

FIG. 17 shows a structural block diagram of a computer device 1700 according to an aspect of this disclosure. The computer device 1700 may be a portable mobile terminal, for example, a smartphone, a tablet personal computer, a moving picture experts group audio layer III (MP3) player, or a moving picture experts group audio layer IV (MP4) player. The computer device 1700 may also be referred to as user equipment, a portable terminal, or another name.

Generally, the computer device 1700 includes: a processor 1701 and a memory 1702.

Processing circuitry, such as the processor 1701 may include one or more processing cores, for example, a 4-core processor or an 8-core processor. The processor 1701 may be implemented by at least one hardware form in a digital signal processing (DSP), a field programmable gate array (FPGA), and a programmable logic array (PLA). The processor 1701 may further include a main processor and a co-processor. The main processor is a processor for processing data in a wake-up state, and is also referred to as a central processing unit (CPU). The co-processor is a low-power processor for processing data in a standby state. In some aspects, the processor 1701 may be integrated with a graphics processing unit (GPU). The GPU is responsible for rendering and drawing content to be displayed by a display screen. In some aspects, the processor 1701 may further include an artificial intelligence (AI) processor. The AI processor is configured to process computing operations related to machine learning.

The memory 1702 may include one or more computer-readable storage media. The computer-readable storage media may be tangible and non-transitory. The memory 1702 may further include a high-speed random access memory and a nonvolatile memory, for example, one or more disk storage devices or flash storage devices. In some aspects, the non-transitory computer-readable storage medium in the memory 1702 is configured to store at least one instruction. The at least one instruction is configured for execution by the processor 1701 to implement the hot zone adjustment method according to aspects of this disclosure.

In some aspects, the computer device 1700 further alternatively includes: a peripheral interface 1703 and at least one peripheral. Specifically, the peripheral includes: at least one of a radio frequency (RF) circuit 1704, a touch display screen 1705, a camera assembly 1706, an audio circuit 1707, and a power supply 1708.

The peripheral interface 1703 may be configured to connect the at least one peripheral related to input/output (I/O) to the processor 1701 and the memory 1702. In some aspects, the processor 1701, the memory 1702, and the peripheral interface 1703 are integrated on a same chip or circuit board. In some other aspects, any one or two of the processor 1701, the memory 1702 and the peripheral interface 1703 may be implemented on a separate chip or circuit board. This is not limited by this aspect.

The RF circuit 1704 is configured to receive and transmit an RF signal, also referred to as an electromagnetic signal. The RF circuit 1704 communicates with a communication network and other communication devices through the electromagnetic signal. The RF circuit 1704 may further include a circuit related to near field communication (NFC). This is not limited in this disclosure. The touch display screen 1705 is configured to display a user interface (UI). The UI may include a graph, text, an icon, a video, and any combination thereof. The camera assembly 1706 is configured to capture images or videos. In some aspects, the camera assembly 1706 includes a front-facing camera and a rear-facing camera. The audio circuit 1707 is configured to provide an audio interface between a user and the computer device 1700. The audio circuit 1707 may include a microphone and a speaker. The microphone is configured to acquire sound waves of the user and an environment, and select the sound waves into an electrical signal to be inputted to the processor 1701 for processing, or inputted to the RF circuit 1704 for implementing voice communication. The power supply 1708 is configured to power the various assemblies in the computer device 1700. The power supply 1708 may be alternating current, direct current, disposable or rechargeable batteries.

In some aspects, the computer device 1700 further includes one or more sensors 1709. The one or more sensors 1709 include, but are not limited to, an acceleration sensor 1710, a gyroscope sensor 1711, a pressure sensor 1712, an optical sensor 1713, and a proximity sensor 1714.

The acceleration sensor 1710 may detect a magnitude of acceleration on three coordinate axes of a coordinate system established with the computer device 1700. The gyroscope sensor 1711 may detect a body direction and a rotation angle of the computer device 1700. The gyroscope sensor 1711 may cooperate with the acceleration sensor 1710 to acquire a 3D action by the user on the computer device 1700. The pressure sensor 1712 may be disposed at a side frame of the computer device 1700 and/or a lower layer of the touch display screen 1705. A grip signal of the user on the computer device 1700 is detected, and/or operable controls on the UI interface may be controlled according to a pressure operation of the user on the touch display screen 1705. The optical sensor 1713 is configured to acquire ambient light intensity. The proximity sensor 1714, also referred to as a distance sensor, is generally disposed on a front surface of the computer device 1700. The proximity sensor 1714 is configured to acquire a distance between the user and the front surface of the computer device 1700.

It is to be understood by a person skilled in the art that the structure shown in FIG. 17 is not limiting of the computer device 1700 and may include more or fewer assemblies than illustrated, or some assemblies may be combined, or different assembly arrangements may be employed.

Aspects of this disclosure also provide a computer device. The computer device includes: a processor and a memory. The memory has at least one computer program stored therein. The at least one computer program is loaded and executed by the processor to implement the hot zone adjustment method provided in the various method aspects.

Aspects of this disclosure also provide a computer storage medium. The computer-readable storage medium has at least one computer program stored therein. The at least one computer program is loaded and executed by a processor to implement the hot zone adjustment method provided in the various method aspects.

Aspects of this disclosure also provide a computer program product. The computer program product includes computer programs. The computer programs are stored in a computer-readable storage medium, such as a non-transitory computer-readable storage medium. The computer programs are read and executed by a processor of a computer device from the non-transitory computer-readable storage medium, whereby the computer device performs the hot zone adjustment method provided in the various method aspects.

The foregoing descriptions are merely example aspects of this disclosure, but are not intended to limit this disclosure. The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive. Any modification, equivalent replacement, or improvement made within the spirit and principle of this disclosure shall fall within the protection scope of this disclosure.

What is claimed is:

1. A hot zone adjustment method, comprising:
displaying, by processing circuitry of a terminal, a hot zone adjustment interface of an application, the hot zone being a touch control region for executing a control function of a virtual character, and the virtual character being configured to move in a virtual world provided by the application;
receiving a user operation for a first hot zone; and
customizing, in response to the user operation for the first hot zone, at least one parameter of the first hot zone.

2. The method according to claim 1, wherein the customizing further comprises:
customizing, in response to a first user operation for the first hot zone, a function parameter of the first hot zone;
customizing, in response to a second user operation for the first hot zone, a location parameter of the first hot zone; and
customizing, in response to a third user operation for the first hot zone, a size parameter of the first hot zone.

3. The method according to claim 2, wherein
the customizing includes the customizing, in response to the first user operation for the first hot zone; and
the customizing, in response to the first user operation for the first hot zone further includes setting, in response to a function setting operation for the first hot zone, a first control function of the first hot zone.

4. The method according to claim 2, wherein
the customizing includes the customizing, in response to the first user operation for the first hot zone; and
the customizing, in response to the first user operation for the first hot zone, further includes switching, in response to a function switching operation for the first hot zone, from a first control function to a second control function of the first hot zone.

5. The method according to claim 2, wherein
the customizing includes the customizing, in response to the second user operation for the first hot zone; and
the customizing, in response to the second user operation for the first hot zone, further includes changing, according to an adjusted location parameter, from an original location parameter to the adjusted location parameter of the first hot zone.

6. The method according to claim 2, wherein
the customizing includes the customizing, in response to the third user operation for the first hot zone; and
the customizing, in response to the third user operation for the first hot zone, further includes changing, according to an adjusted size parameter, from an original size parameter to the adjusted size parameter of the first hot zone.

7. The method according to claim 1, further comprising:
displaying, based on historical touch behavior data of the terminal, a recommended hot zone on the hot zone adjustment interface of the application.

8. The method according to claim 7, further comprising:
generating the recommended hot zone by connecting a plurality of contact points with frequency greater than a threshold, the historical behavior data including a touch region based on the plurality of contact points.

9. The method according to claim 7, further comprising:
generating the recommended hot zone by connecting historical touch points overlapping within a range greater than a threshold, the historical behavior data including the historical touch points.

10. The method according to claim 1, further comprising:
obtaining a tilt angle and a tilt direction of the terminal; and
displaying, based on the tilt angle and the tilt direction, at least one offset hot zone on the hot zone adjustment interface of the application.

11. The method according to claim 10, further comprising:
determining an offset distance of the at least one hot zone based on the tilt angle;
determining an offset direction of the at least one hot zone based on the tilt direction; and
displaying, based on the offset distance and the offset direction, the at least one offset hot zone on the hot zone adjustment interface of the application.

12. A hot zone adjustment apparatus, the apparatus comprising:
processing circuitry configured to:
display a hot zone adjustment interface of an application, the hot zone being a touch control region for executing a control function of a virtual character, and the virtual character being configured to move in a virtual world provided by the application;
receive a user operation for a first hot zone; and
customize at least one parameter of the first hot zone in response to the user operation for the first hot zone.

13. The apparatus according to claim 12, the processing circuitry further configured to:
display, based on historical touch behavior data of the apparatus, a recommended hot zone on the hot zone adjustment interface of the application.

14. The apparatus according to claim 13, the processing circuitry further configured to:
generate the recommended hot zone by connecting a plurality of contact points with a frequency greater than a threshold, the historical behavior data including a touch region based on the plurality of contact points.

15. The apparatus according to claim 13, the processing circuitry further configured to:
generate the recommended hot zone by connecting historical touch points overlapping within a range greater than a threshold, the historical behavior data including the historical touch points.

16. A non-transitory computer-readable storage medium, storing instructions which when executed by a processor cause the processor to perform:
displaying a hot zone adjustment interface of an application, the hot zone being a touch control region for executing a control function of a virtual character, and the virtual character being configured to move in a virtual world provided by the application;
receiving a user operation for a first hot zone; and
customizing at least one parameter of the first hot zone in response to the user operation for the first hot zone.

17. The non-transitory computer-readable storage medium according to claim 16, wherein the instructions when executed by the processor further cause the processor to perform:
displaying, based on historical touch behavior data of the terminal, a recommended hot zone on the hot zone adjustment interface of the application.

18. The non-transitory computer-readable storage medium according to claim 17, wherein the instructions when executed by the processor further cause the processor to perform:
generating the recommended hot zone by connecting a plurality of contact points at a frequency greater than a threshold, the historical behavior data including a touch region based on the plurality of contact points.

19. The non-transitory computer-readable storage medium according to claim 17, wherein the instructions when executed by the processor further cause the processor to perform:
generating the recommended hot zone by connecting historical touch points overlapping within a range greater than a threshold, the historical behavior data including the historical touch points.

20. The non-transitory computer-readable storage medium according to claim 16, wherein the instructions when executed by the processor further cause the processor to perform:
obtaining a tilt angle and a tilt direction of the terminal; and
displaying, based on the tilt angle and the tilt direction, at least one offset hot zone on the hot zone adjustment interface of the application
